(19) United States
(12) Patent Application Publication
(10) Pub. No.: US 2017/0103371 A1
(43) Pub. Date: Apr. 13, 2017

(54) CROSS ASSET TRADE OFF ANALYSIS FOR ROADWAY NETWORKS

(71) Applicants: Branislav POSAVLJAK, Lincoln, NE (US); Milos POSAVLJAK, Kitchener (CA)

(72) Inventor: Milos POSAVLJAK, Kitchener (CA)

(21) Appl. No.: 15/330,728

(22) PCT Filed: Aug. 21, 2014
(86) PCT No.: PCT/US2014/000182

§ 371 Date: Nov. 2, 2016

(51) Int. Cl. G06Q 10/00; G06Q 40/06

(52) U.S. Cl. CPC G06Q 10/20; G06Q 40/06

(57) ABSTRACT

Roadway infrastructure is considered one of the largest tangible assets. Modern roadway networks have been constructed over the last century. The present day challenge in their management is determining how to allocate scarce resources among essentially different asset categories and types of needs. Roadway agencies must determine what funds to allocate by asset type, including pavement (roads), structures (bridges and culverts), safety features (guide rails), and other assets. Decisions must be made regarding their competing needs for asset replacement, rehabilitation, routine maintenance, and improvement. Funding allocation across these areas is a significantly complex problem requiring consideration of organizational capacity, objectives and constraints. The invention provides a means for treating bridges as equivalent pavement sections. It introduces an already widely accepted pavement performance measure as an overall single performance measure for pavements and bridges. This allows conduction of investment planning for roads in a manner which maximizes roadway asset performance while optimizing funding.

### BACKGROUND OF THE INVENTION

The roadway asset management industry has developed a set of tools and approaches to assist in resource allocation. It has become standard for organizations to define performance measures for quantifying overall conditions of their assets, and to compare alternatives of investment scenarios. Pavement and bridge management systems have been developed to help prioritize competing needs and to forecast future corresponding asset performance. Moving forward, an emphasis has been put on developing approaches for resource allocation across asset classes.

The current approaches in roadway asset management contain a significant deficiency in that resource allocation is addressed only within a single asset class with a narrow perspective on performance. They provide little guidance for allocating a fixed funding budget among, for example, pavement resurfacings, culvert replacements, and bridge widenings in order to enhance safety and reliability, and to accommodate traffic. There are no widely accepted approaches for assessing how condition and performance of separate classes of assets interact to influence overall system performance. Research is needed to determine how to align asset-specific performance measures with an agency's system performance targets, and how to allocate resources across asset classes to achieve satisfactory performance. A research project tender put forth by the Transportation Research Board of the United States National Academy of Sciences titled “Cross-Asset Resource Allocation and the Impact on System Performance”, NCHRP 08-91 [Pending], 2012, contains the above assessment of the current state of the art.

On behalf of the California Department of Transportation, CTC & Associates LLC investigated roadway asset management and related processes of other state departments of transportation. They also identified domestic and international research that addresses the current state of the practice in applying cross-asset optimization in roadway asset management. The findings indicate burgeoning interest in cross-asset optimization, but no transportation state department has completed a comprehensive implementation of cross-asset optimization. The CTC & Associates LLC report is titled: “Application of Cross-Asset Optimization in Transportation Asset Management: A Survey of State Practice and Related Research, 2012”.

On behalf of the New Jersey Department of Transportation, Cambridge Systematics Inc. performed a review of current practice relating to cross-asset funding analysis. The report found that “the most common approach implemented for cross-asset allocation is performance targeting, where targets are set for key performance measures and then asset management systems are used to predict performance given a budget scenario.” It also proposed a new-utility function approach for the Department to use, which is based upon travel time savings, operating cost savings, and reductions in accident costs. Despite having a similar goal of optimal funding allocation across assets, the invention and the mentioned report's approach differ in their essence.

The latest initiative for developing reliable cross-asset resource allocation is the public tender by the Transportation Research Board of the National Academies valued at $ 500 000 with an 18 month contract time. The NCHRP 08-91 has been awarded to a consultant, and it is scheduled for completion in August 2014. Part of the project calls for a workshop with practitioners of various Departments of Transportation to assess the practicality of applying the approaches to optimal resource allocation and refining the proposed measures and methods. The scope of this project is the most relevant prior art. A pdf version of the presentation used for the workshop on Apr. 28, 2014 is available at: http://onlinepubs.trb.org/onlinepubs/conferences/2014/AssetManagement2014/Maggiore% 20-%20Workshop%20Cross%20Asset.pdf.

The consultant's product is expected to produce a guidebook which is not intended to be an optimization tool, but rather an explanation of principles and procedure that may be adapted and used by a transportation asset management agency to support allocation of public resources across transportation-system asset classes to achieve acceptable system performance. Despite the goal of the invention and the NCHRP 08-91 project being quite similar, the presentation material does not include information common to the process contained within the invention.

Core items to be addressed through NCHRP 08-91 include but are not limited to:

(a) suggest the fundamental dimensions necessary to measure and communicate transportation system performance across asset categories and alternative metrics applicable to each dimension;

(b) be adaptable for use by any particular DOT or other transportation agencies at various levels of transportation asset management maturity;

(c) present succinct and easily comprehended exemplary reports of performance implications of resource allocations to specific assets or asset classes;

(d) be responsive to the accountability, performance measurement and management provisions of MAP-21; and

(e) be useful as a tool to facilitate communication between stakeholders and transportation-agency officials about the likely impacts of cross-asset resource-allocation decisions. The research should identify data and training requirements for an agency to apply the framework and incorporate its use in cross-asset resource allocation.

The invention named “Cross-Asset Funding Trade-Off Analysis for Roadway Networks or Caftafrn” provides an efficient, effective, and essential means of significantly advancing agencies' current cross-asset initiatives mentioned above as well as NCHRP 08-91's work scope objectives. Specifically, it provides a means for roadway managing agencies to allocate limited funding between pavements and bridge assets through an objective trade-off process, based on the monetary system.

### SUMMARY OF THE INVENTION

It is assumed that the public agencies' general goal is to maximize roadway asset performance while optimizing funds or value. Amongst others, two main elements of a roadway network are the pavement and bridge networks. The pavement network is composed of a finite number of individual pavement sections. The bridge network is composed of a finite number of individual bridges. The pavement section and the bridge are intrinsically different structures, behaving differently, involving different design processes, requiring different construction and rehabilitation methods, and different performance measures. In light of this, the cost associated with “rehabilitating” a pavement section and “rehabilitating” a bridge is different, assuming the associated condition improvement of each asset element is comparable internally within each asset category. For example, the pavement section condition improved to “very good”, and the bridge condition improved to “very good” as well.

Currently considered advanced management practice typically involves setting network performance targets, independently programming each network, and then potentially varying available funding over a multi-year period to observe effect on each asset network. Another approach involves a third network program expressed in terms of a new “utility” (e.g. a “health index”) which an agency may consider to be indicative of overall roadway performance.

Both approaches claim the interpretation of being a “cross-asset” means of optimization or resource allocation. However, with the exception of the action of making a decision on which asset to spend funds, a literature review shows no evidence of actual objective trade-off between the pavement and the bridge assets with respect to their performance and cost, and the overall performance of the network. In light of this, NCHRP 08-91 states, “There are no widely accepted approaches for assessing how condition and performance of separate classes of assets interact to influence overall system performance.”

The Caftafrn invention is a method allowing for the conversion or representation of a bridge as an equivalent pavement section. One asset network with one performance measure is the result. The bridge deck area is converted to an equivalent pavement area. Introduction of a new “utility” is avoided by conversion of the relatively developed Bridge Condition Index into an established pavement performance measure such as the Riding Comfort Index. This allows for allocation of funds across the bridge and pavement assets such that long term performance of the one roadway asset is maximized while funding is optimized.

The Caftafrn invention is a financial instrument which includes the following steps:
1. Calculation of average historical costs of routine maintenance, preservation, and rehabilitation treatments for pavements and bridges, respectively.
2. Calculating the ratio of bridge to pavement costs from step 1.
3. Calculating the average of ratios from step 2, thereby deriving the Structural Integration Factor.
4. Multiplication of each bridge deck area by the Structural Integration Factor, thereby converting the bridge deck area into an equivalent pavement section area.

In order to use Caftafrn for short, medium and long term program planning it is necessary to next convert the bridge performance measure into an equivalent pavement performance measure. For example, in cases where the designated pavement performance measure is the Riding Comfort Index, the Bridge Condition Index would be scaled by a scalar multiplication of 0.10. In cases where lower numbers indicate increased pavement performance, inversion of scale is necessary in addition to appropriate scalar multiplication. This brings into existence one performance measure for the one roadway asset. Finally, it is necessary to decrease the deterioration rate of the equivalent pavement sections to an appropriate level. This is required as the equivalent pavement section is in reality an existing bridge. For appropriately designed, constructed and maintained assets; typical life spans for pavements and bridges prior to major rehabilitation are greater than 20 years and greater than 40 years, respectively.

### DETAILED DESCRIPTION OF THE INVENTION

While the Structural Integration Factor may be interpreted as a mathematical method of determining averages, multiplication of the bridge deck area by the Structural Integration Factor provides a novel financial instrument that is essential for objective cross-asset trade-off analysis. Integration of the Bridge Condition Index into an equivalent Pavement Condition Index, along with an adjusted deterioration rate for equivalent Pavement Condition Index, composes the financial instrument named “Cross-Asset Funding Trade-Off Analysis for Roadway Networks” or “Caftafrn”. This provides for a new way of doing trade-off funding analysis between the assets of pavements and bridges. It offers a new technical solution for the problem of developing an industry-wide acceptable performance measure for the one roadway asset composed of two main and distinctly different parts—the pavement and bridge networks.

Caftafrn is the application of the Structural Integration Factor coupled with bridge integration into the pavement network. Core Caftafrn uses include but are not limited to:
performing trade-off funding analysis or cross-asset fund allocation,
developing an optimized 25 year asset improvement plan,
assisting in or performing fund allocation decision making,
assisting in or performing investment planning.

Caftafrn is a novel financial instrument for public infrastructure management, specifically roads and bridges.

The trading-off between pavements and bridges through Caftafrn requires only one (1) computer algorithm to optimize the performance of the network. Without Caftafrn, the minimum number of algorithms required is three: bridge management system algorithm, pavement management system algorithm, and a trade-off analysis algorithm between the two, likely expressed in terms of a new utility.

The latest academia papers generally suggest introduction of a unified “utility” performance measure for both pavements and bridges, such as a “health index”, which is not an established or widely accepted performance measure within the industry. As such, Caftafrn carries a significant advantage as its unified performance measure can be one of the many pavement performance measures that have been widely accepted by academia and industry over the past decades. The pavement performance measure is the single subject of maximization within Caftafrn.

Generally a roadway agency includes an organizational unit for determining future pavement needs and a separate unit for determining future bridge needs. Subsequently, it is common for the majority of agencies to develop short, mid, and long term investment plans for pavement and bridge assets through mutually exclusive organizational processes.

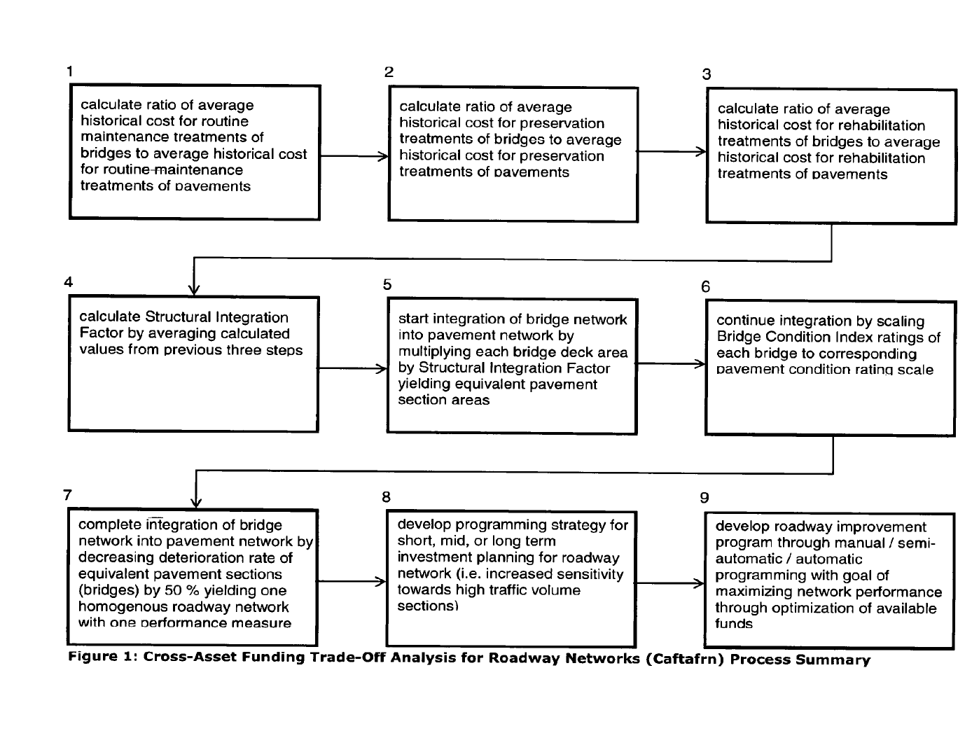

If limited budget allows for repair of either two bridges or one pavement section, assuming the former yields a higher performance increase for the bridge network than the latter for the pavement network, the option of repairing two bridges will likely be pursued by the agency. However, the same approach decreases in reliability as the planning period increases. This is mainly due to increasing uncertainty in predicting future available budgets for years 3 to 25, but especially due to lack of an objective means of trading-off bridge and pavement assets. FIG. 1 provides a diagram summarizing the Caftafrn process.

The Structural Integration Factor is an element of Caftafrn which is necessary for reliable long-term funding trade-off analysis between the two assets of pavements and bridges.

Provided both are engineered facilities, which require two different engineering expertise of pavement and structural knowledge, the Structural Integration Factor concentrates on the value of the three terms common to improving both assets' conditions: routine maintenance, preservation, and rehabilitation.

Integration of a bridge to an equivalent pavement section includes the following steps:
Averaging of each treatment cost term for bridges;
Averaging of each treatment cost term for pavements;
Determining bridge to pavement cost ratio for average cost of routine maintenance;
Determining bridge to pavement cost ratio for average cost of preservation;
Determining bridge to pavement cost ratio for average cost of rehabilitation; and
Averaging of all three ratios.

The average of three ratios represents the Structural Integration Factor, as shown in the first four steps in FIG. 1. The deck area of each bridge is multiplied by the Structural Integration Factor to integrate the bridge network into the pavement network.

In order for bridges to be treated as pavement sections in short, mid and long term investment program planning, the following is performed on each bridge to provide a homogenous pavement network:
Bridge Condition Index division by a factor of ten (10); and
Converting of Bridge Condition Index to Riding Comfort Index with a 50% lower deterioration rate than that of an actual pavement section

This is shown in steps 6 and 7 of FIG. 1. The factor of ten (10) is arbitrary as it allows for proper scaling of the Bridge Condition Index with the Riding Comfort Index. This avoids the need to develop a separate condition index representing both assets. A 50% lower deterioration rate is representative of assuming a 15 year required time span to the first significant rehabilitation for a pavement section, and approximately a 30 year time span of the same for a bridge.

The result is one homogenous network of pavement sections with one distinct performance measure, the Riding Comfort Index. The network improvement program may then be developed. Depending on organizational capacity, development may include a process that is manual, semi-automated, or fully automated. Technological means of accommodating this program may include but are not be limited to: Microsoft Excel, Commercial off-the-shelf applications, net applications, or existing organizational software systems. FIG. 2 shows the application of Caftafrn in Microsoft Excel.

Steps 1 to 5 of FIG. 2 show the Microsoft Excel code necessary for achieving steps 1 to 5 of the flow diagram in FIG. 1. Step 6 shows the Bridge Condition Index ratings already scaled down to a Riding Comfort Index pavement condition scale. A Bridge Condition Index rating of “63” has been converted to “6.3” within the Riding Comfort Index scale. The Microsoft Excel code includes values of 1, 2, and 3 for routine maintenance, preservation, and rehabilitation, respectively. Routine maintenance and preservation increase the condition for 5 and 15 years prior to it returning to its initial state, respectively. Rehabilitation improves the condition to a maximum rating of 8.73. If no treatment is applied, the equivalent pavement section deterioration rate is that of an actual section of 0.123 per year divided by two. Step 7 shows the automatization of the program. When the Riding Comfort Index drops below the trigger values of 7.5, 6.4, and 4.5, routine maintenance, preservation, and rehabilitation treatments are applied respectively. The user would subsequently manually remove treatments from the program such that the budgetary restriction is satisfied. An investment strategy sensitive to higher volume sections would see the removal of treatments from low traffic volume sections first.

The resulting roadway improvement program may provide a sequence of construction projects such that future network performance is maximized while funding optimized, or help the agency meet network performance targets, implement specific investment strategies or any other related goals.

Two 25 year roadway network programs were developed for the same model network using two different methods: current industry practice and Caftafrn.

The current industry practice is mutually exclusive as the bridge network needs and performance are determined without considering pavement performance, and vice versa. Furthermore, the process does not consider performance maximization of the overall roadway network of which both are integral parts. Performances of the bridge and pavement networks are expressed with completely different performance measures without a distinct relation between them, and without a unified performance measure for the “roadway network”.

The Caftafrn process is mutually inclusive as the bridges are integrated into pavement sections prior to determining needs and associated performance.

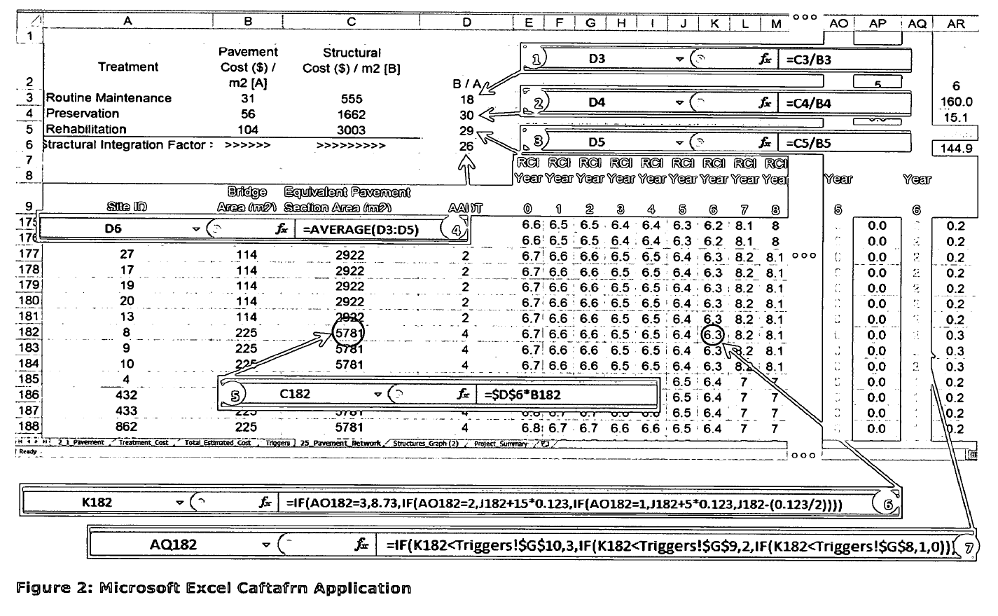

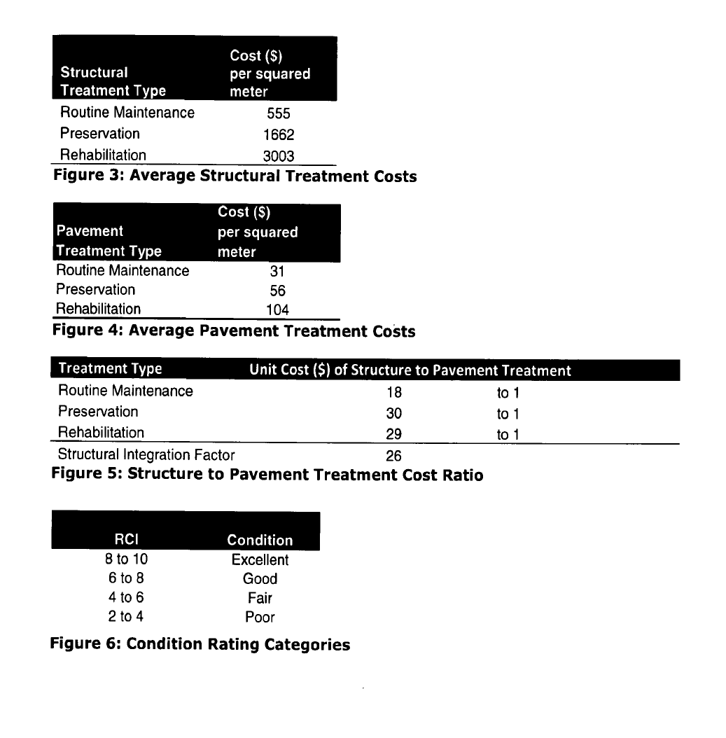

FIGS. 3 and 4 show examples of average treatment costs per one squared meter of bridge deck and pavement section, respectively. Costs' magnitudes are loosely based on historical averages from a roadway managing agency. The values have been multiplied by a scalar and are not representative of actual values. The values themselves are relatively insignificant to the concept; however, their ratio is essential.

Cost ratios of the information contained in the above tables and their averages are calculated in FIG. 5.

By averaging cost ratios of all treatment types, the Structural Integration Factor is calculated to be 26. The conversion formula for a structure to an equivalent pavement section is as follows:

$$Equivalent Pavement Section Area = Deck Area of Structure \times Structural Integration Factor ( S I F )$$

Where:
   Equivalent Pavement Section Area is expressed in meters squared
   Deck Area of Structure is expressed in meters squared
   SIF value was determined from FIG. 5 to be 26

Theoretically, the Structural Integration Factor accounts for the material and labour difference of constructing a structure compared to an equivalent pavement section of typical cross sectional characteristic, as per the specific agency's design standards for specific site conditions.

The following includes a comparison of 25 year investment plans developed through typical industry practice and the Caftafrn method. Use of the Caftafrn process yields increased roadway asset performance compared to the current method of fund allocation employed by the roadway asset managing industry.

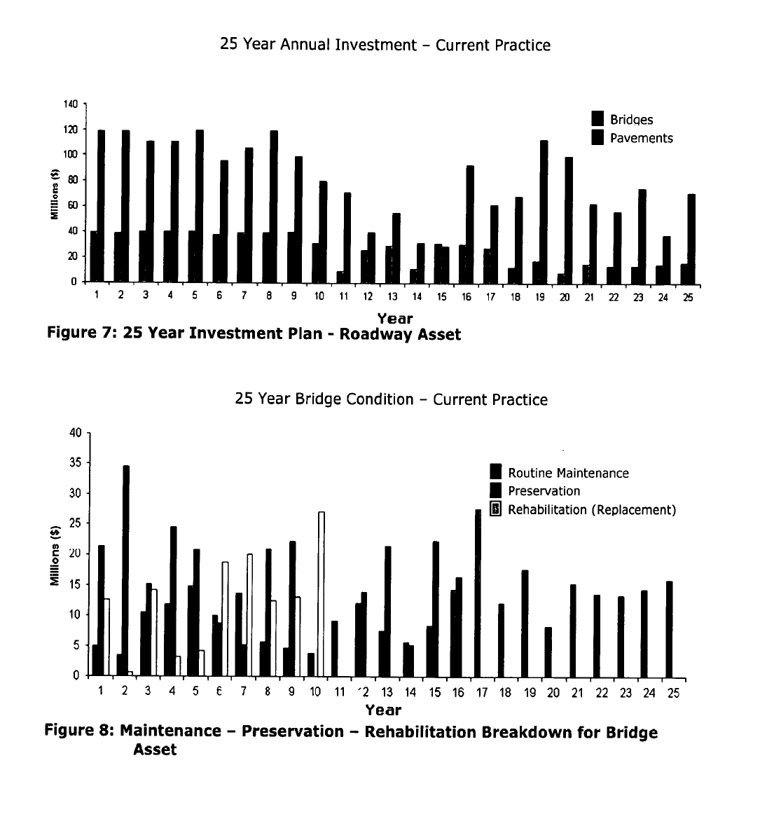

FIG. 7 contains the result of a 25 year program developed through typical industry practice means without Caftafrn. Each sub asset was analyzed independently with separate budgets.

An annual budgetary constraint of $ 120 M for the pavement asset was determined to be necessary, in order to avoid a significant portion of the network performing below the minimum allowable individual section thresholds.

A programming strategy of treating high traffic volume sections and bridges first was applied. A higher number of lanes in each direction is associated with higher traffic volumes.

The Structural Integration Factor was not used in this method for selection of pavement or bridge units for treatment. However, it did play a significant role in determining the annual budgetary constraint of $ 40 M for the bridge asset. Once the entire bridge asset was converted to an equivalent pavement network, its pavement area was determined to be 34% of the pavement asset. Rounding down to 30% of the pavement asset's budget constraint was assumed satisfactory.

The present worth value at a 5% discount rate is equal to $ 418 M for the bridge asset with an average 25 year Bridge Condition Index of 72.0, which is considered at the lower limit of the “Good” rating category. FIG. 4 shows the condition rating categories.

The present worth value at a 5% discount rate is equal to $ 1,243 M for the pavement asset with an average 25 year Riding Comfort Index of 7.2, which is at the higher limit of the “Good” rating category.

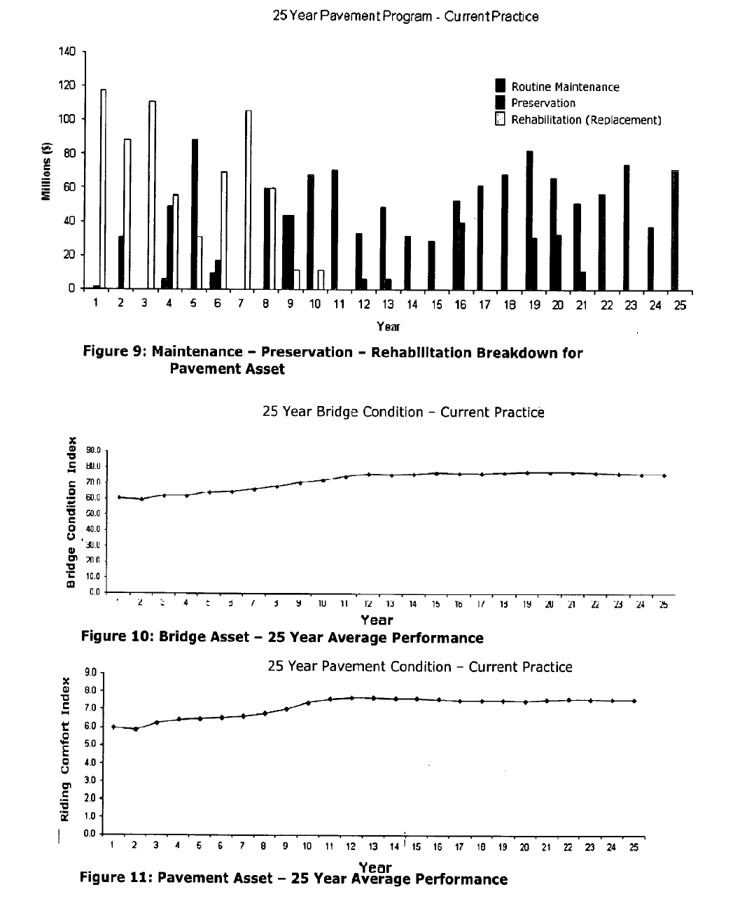

The investment bar graph pattern is indicative of significant investments into preservation and rehabilitation of the network in the first ten (10) years, followed by 15 years of mainly routine maintenance and preservation. FIGS. 8 and 9 provide an illustration of this pattern. Relative to the pavement network, the bridge asset includes a greater balance between the three treatments in the 10 to 15 year span. The pavement asset includes a higher focus on rehabilitation treatments in the 10 year span. The drop-off in needed investment to maintain a sustainable network condition around year ten (10) is expected given that preservation and rehabilitation treatments yield generally a minimum 10-15 year conditional sustainability of the roadway network. The 10+ year span includes a combination of maintenance and preservation treatments, with the former dominating.

While the investment needs pattern is relatively representative of historic roadway asset deterioration and rehabilitation behaviour, it should be noted that the budgetary allowance of the plan is highly optimistic and inconsiderate of economic uncertainty.

The programming method is semi-automated, with the goal of optimizing the allowed budget while maximizing asset performance. Full programming automatization is encouraged; however, a thorough manual review of the resulting long term plan is strongly suggested prior to implementation, due to the economic value of the commitment and the magnitude of risk due to potential errors resulting from automatization.

FIGS. 10 and 11 illustrate the average bridge and pavement condition performances, respectively.

A “Good” average rating of the bridge network is reached in year nine (9). The maximum rating of 7.7 Bridge Condition Index is reached in year 12.

The lower limit of the “Good” average rating range is reached in year four (4), while the mid point of the range is reached in year nine (9). The maximum rating of 7.7 Riding Comfort Index is reached in year 12.

The performance curve of both assets is considered optimistic due to a relatively stable allowable budget assumption. Variation of annual budgets and performance targets is encouraged in developing the optimal sequence of sections, bridges, and corresponding treatments aimed at maximizing roadway asset performance through optimization of available means.

The inherent deficiency of current investment planning practice is that there are two separate asset networks, with separate budgets, and most importantly two different performance indices for the one roadway asset. The redundant performance indicator yields to goal attainment uncertainty, due to lack of an indicator assuring that independent asset budget optimization and performance maximization yields an identical result regarding optimization, with respect to the one roadway asset network.

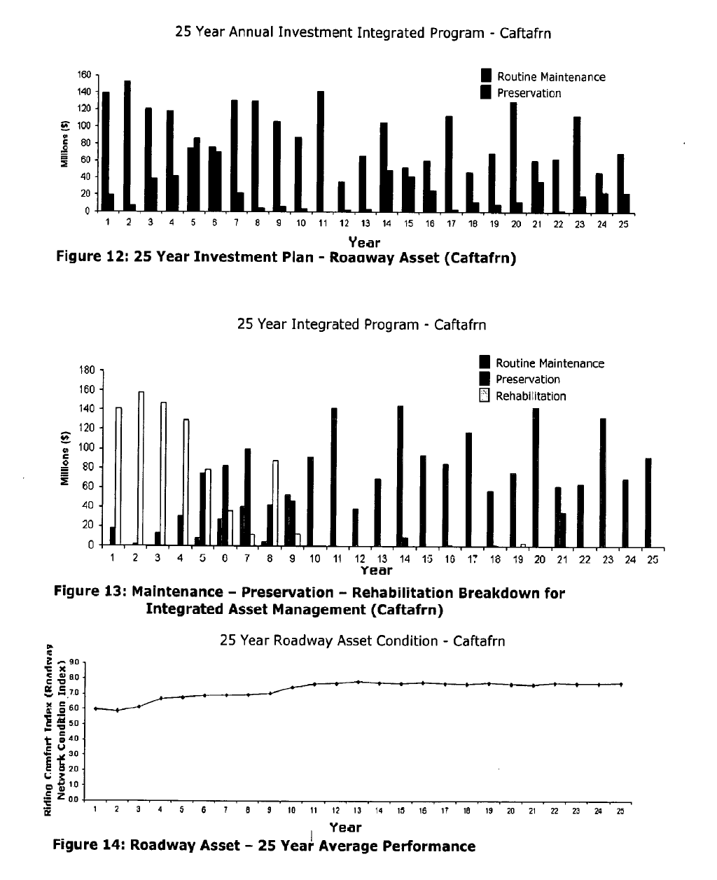

FIG. 12 illustrates the resulting 25 year investment plan for the roadway asset via Caftafrn.

A total budgetary allowance of $ 160 M per year is maintained as in the previous method of 25 year programming. The same strategy of treating high traffic volume sections first was applied. A higher number of lanes in each direction is associated with higher traffic volumes.

The total present worth value at a 5% discount rate is equal to $ 1,734 M, with an average Riding Comfort Index of 7.3. Considering the structures as equivalent pavement sections, their present worth value is $ 344 M of the total value, with $ 1,390 M allocated to actual pavement sections.

FIG. 12 is illustrative of the Caftafrn's ability to annually vary the investment balance between the pavement and bridge assets over the long term, such that the overall asset condition is maximized through budget optimization.

The investment bar graph pattern is indicative of significant investments into preservation and rehabilitation of the network in the first nine (9) years, followed by 16 years of mainly routine maintenance and preservation. FIG. 13 illustrates this pattern. The drop-off in needed investment to maintain a sustainable network condition around year nine (9) is expected, given that preservation and rehabilitation treatments yield generally a minimum 10-15 year conditional sustainability of the roadway network. The 10+ year span includes a combination of maintenance and preservation treatments, with the former dominating.

While the investment needs pattern is relatively representative of historic roadway asset deterioration and rehabilitation behaviour, it should be noted that the budgetary allowance of the plan is highly optimistic and inconsiderate of economic uncertainty.

The programming method is semi-automated, with the goal of optimizing the allowed budget while maximizing asset performance. Full programming automatization is encouraged; however, a thorough manual review of the resulting long term plan is strongly suggested prior to implementation, due to the economic value of the commitment and the magnitude of risk due to potential errors resulting from automatization.

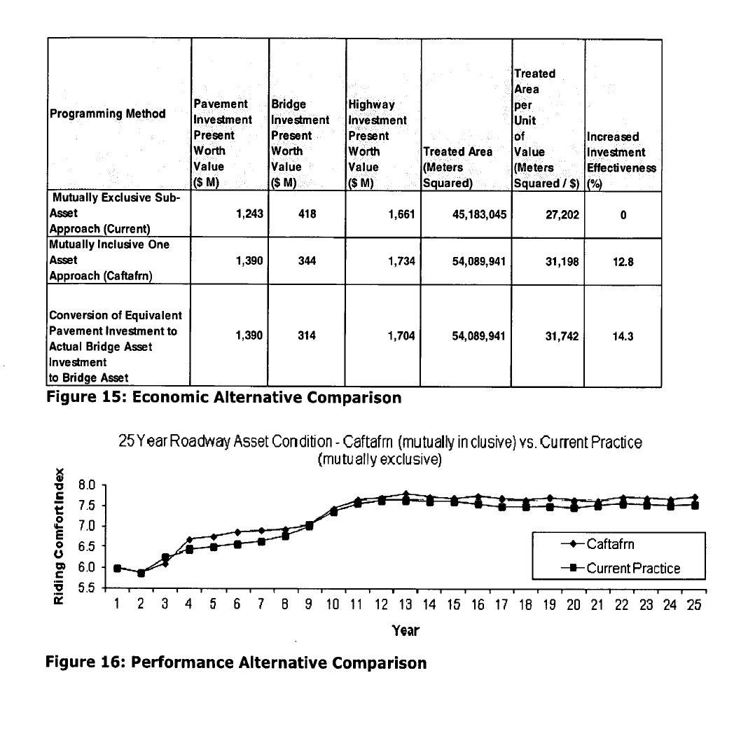

FIG. 14 illustrates the average roadway asset condition. The condition is expressed in terms of the Riding Comfort Index which may be theoretically considered as representing the Roadway Network Condition Index due to integration of the structural network into an equivalent pavement network.

The lower limit of the “Good” average rating range is reached in year four (4), while the mid point of the range is reached in year six (6). The maximum rating of 7.8 Riding Comfort Index is reached in years 13 and 16.

The performance curve is considered optimistic due to a relatively stable allowable budget assumption. Variation of annual budgets and performance targets is encouraged in developing the optimal sequence of sections and corresponding treatments aimed at maximizing roadway asset performance through optimization of available means.

The inherent deficiency of two separate asset networks, with separate budgets, and most importantly two different performance indices for the one roadway asset are eliminated through application of Caftafrn.

The following contains an analysis of the two methods used to develop the two long term investment plans.

FIG. 15 contains a comparison of the methods' respective effectiveness of maximizing the area of network treated by optimization of funds.

Pavement, bridge, and roadway present worth values are shown in the first three columns. Area of network treated, and resulting “benefit/cost” ratio expressed as area of network treated per one unit of value, are shown in the last two table columns. Caftafrn, the mutually inclusive programming approach, results in an approximate 13% increase in investment effectiveness when compared to mutually exclusive asset planning, as shown in the last column of FIG. 15.

Effectiveness is slightly higher at 14% when actual bridge asset treatment costs are used rather than equivalent pavement section costs. It is important to note that the treated area shown in all rows includes the actual bridge network area treated rather than equivalent pavement section area. The last two rows represent the same Caftafrn mutually inclusive program, except actual bridge costs are shown in the last row. The use of actual bridge costs results in a $ 30 M lower bridge expenditure of $ 314 M from $ 344 M. This conversion is necessary for assessing the exact value of the long term bridge asset program. Tracking of aggregate treatment costs for routine maintenance, preservation, and rehabilitation allows for this conversion upon completion of programming.

In addition to improved investment effectiveness, Caftafrn resulted in a slightly higher average asset performance level of 7.3 Riding Comfort Index compared to 7.2 Riding Comfort Index. FIG. 16 illustrates the performance gap over the long term.

With the exception of the first three years, the mutually exclusive method of investment planning (current industry practice) consistently yields a lower annual performance level of the network over the long term. Caftafrn demonstrates a higher level of goal attainment with respect to maximizing network performance by optimization of value.

A potential explanation of the above pattern is the agencies' lack of flexibility in balancing the long term budgets between the two main assets of bridges and pavements. In treating them as completely separate networks and developing long term prioritization needs in separate organizational units, the potential for debt incurrence due to unused funds and suboptimal performance of the roadway asset increases.

Another advantage of Caftafrn is the ability to express the roadway asset condition with one performance indicator, thereby objectively quantifying how condition and performance of separate classes of assets interact to influence overall system performance. Equally important is that this indicator is not a new term with which the industry would have to familiarize itself with, but rather the Bridge Condition Index can be integrated into existing pavement performance indicators of an agency's choice such as the Riding Comfort Index.

The Caftafrn invention provides an effective and novel means of achieving maximized roadway network performance through optimization of available funds. Its potential widespread use will highly likely yield improved organizational efficiencies of roadway managing agencies. Caftafrn outperforms the current industry method of treating the bridge and pavement assets as separate networks for the purposes of investment planning.

The embodiments of the invention in which an exclusive property or privilege is claimed are defined as follows:

1. A financial process for short, mid and long-term cross-asset roadway network funding allocation programming for pavements and bridges, which comprises of converting bridge structures into equivalent pavement sections, and integrating the bridge condition indicator into a pavement condition indicator; named Cross-Asset Funding Trade-Off Analysis for Roadway Networks or Caftafrn.

2. A process as defined in claim 1, in which the bridge deck surface area is multiplied by the Structural Integration Factor to yield an equivalent pavement section surface area.

3. A process as defined in claim 1, in which the roadway network undergoing funding allocation programming consists of actual pavement sections and equivalent pavement sections, which are bridge structures in the physical environment.

4. A process as defined in claim 1, in which roadway cross-asset funding allocation analysis consists of developing an improvement program for the roadway network to accomplish roadway managing agencies' goals, which include but are not limited to:
Assessing how condition and performance of pavements and bridges interact to influence overall system performance;
Maximization of roadway asset performance;
Optimization of funding budgets;
Aligning of pavement and bridge specific performance measures with overall system performance targets;
Funding allocation to achieve overall satisfactory system performance;
Analyzing and communicating the likely system performance impact of investment decisions across multiple types of transportation assets;
Aiding senior executives, elected officials, and the public to understand the performance consequences of asset-specific investments in their transportation system;
Elimination of potential obstacles to data-driven, performance-based, cross-asset resource allocation in managing agencies.

5. A short, mid and long-term time period of claim 1 wherein it comprises a time span of zero to infinite years.

6. A roadway asset of claim 4 wherein it comprises of the following but is not limited to: pavements, bridges, culverts, guiderails, signs, ditches, pavement markings, illuminates.

7. A Structural Integration Factor as claimed in claim 2, which consists of the bridges to pavements improvement cost ratio.

8. An improvement cost ratio as claimed in claim 7, consisting of the average bridges' routine maintenance, preservation and replacement costs to the average of pavements' routine maintenance, preservation and rehabilitation costs.

9. The bridges' routine maintenance costs as claimed in claim 8, consisting of average historical costs per an area unit of bridge deck for treatments defined as routine maintenance, or an equivalent term as defined by a roadway managing agency using the invention.

10. The bridges' preservation costs as claimed in claim 8, consisting of average historical costs per an area unit of bridge deck for treatments defined as preservation, or an equivalent term as defined by a roadway managing agency using the invention.

11. The bridges' replacement costs as claimed in claim 8, consisting of average historical costs per an area unit of bridge deck for treatments defined as replacement, or an equivalent term as defined by a roadway managing agency using the invention.

12. The pavements' routine maintenance costs as claimed in claim 8, consisting of average historical costs per an area unit of pavement for treatments defined as routine maintenance, or an equivalent term as defined by a roadway managing agency using the invention.

13. The pavements' preservation costs as claimed in claim 8, consisting of average historical costs per an area unit of pavement for treatments defined as preservation, or an equivalent term as defined by a roadway managing agency using the invention.

14. The pavements' rehabilitation costs as claimed in claim 8, consisting of average historical costs per an area unit of pavement for treatments defined as rehabilitation, or an equivalent term as defined by a roadway managing agency using the invention.

15. The bridges' treatments defined as routine maintenance or an equivalent term claimed in claim 9, wherein examples include but are not limited to: concrete patch repairs, crack injection, and other treatments as defined by applicable design guides, policies, specifications, and standards, which a roadway managing agency using the invention references or abides by.

16. The bridges' treatments defined as preservation or an equivalent term claimed in claim 10, wherein examples include but are not limited to: approach slab improvements, deck joint improvements, parapet wall improvements, bearing improvements, semi-integral abutment conversion, concrete overlay, and other treatments as defined by applicable design guides, policies, specifications, and standards, which a roadway managing agency using the invention references or abides by.

17. The bridges' treatments defined as replacement or an equivalent term claimed in claim 11, wherein examples include but are not limited to: full replacement of deck, beams, foundations and/or abutments, and other treatments as defined by applicable design guides, policies, specifications, and standards, which a roadway managing agency using the invention references or abides by.

18. The pavements' treatments defined as routine maintenance or an equivalent term claimed in claim 12, wherein examples include but are not limited to: rout and seal, drainage maintenance, and other treatments as defined by applicable design guides, policies, specifications, and standards, which a roadway managing agency using the invention references or abides by.

19. The pavements' treatments defined as preservation or an equivalent term claimed in claim 13, wherein examples include but are not limited to: cold-in-place recycling, hot mix overlays, milling with hot mix overlays, concrete surface rehabilitation, concrete overlay, and other treatments as defined by applicable design guides, policies, specifications, and standards, which a roadway managing agency using the invention references or abides by.

20. The pavements' treatments defined as rehabilitation or an equivalent term claimed in claim 14, wherein examples include but are not limited to: removal of existing full pavement structure and re-compaction of the subgrade and complete replacement of the pavement structure, and other treatments as defined by applicable design guides, policies, specifications, and standards, which a roadway managing agency using the invention references or abides by.

21. The cross-asset roadway network funding allocation programming, as claimed in claim 1, includes the development of roadway improvement project sequences; whereas, each sequence represents a construction scenario.

22. The construction scenario of claim 21, wherein the number of such scenarios is unlimited, but subject to a roadway managing agency's preference.

23. A bridge condition indicator claimed in claim 1, wherein represents a quantified measure of bridge performance, used by a roadway managing agency to communicate the condition or performance of a bridge or bridge network, where examples include but are not limited to: Bridge Condition Index, National Bridge Index, and other measures as defined by applicable design guides, policies, specifications, and standards, which a roadway managing agency using the invention references or abides by.

24. A pavement condition indicator claimed in claim 1, wherein represents a quantified measure of pavement condition performance used by a roadway managing agency to communicate the condition of a pavement section or network, where examples include but are not limited to: International Riding Index, Roughness Condition Index, Distress Manifestation Index, and other measures as defined by applicable design guides, policies, specifications, and standards, which a roadway managing agency using the invention references or abides by.

25. The integration of the bridge condition indicator into a pavement condition indicator as claimed in claim 1 consists of:
adjusting the bridge condition scale to fit limits and increasing/decreasing trends of the pavement condition indicator scale;
decreasing the equivalent pavement sections' deterioration rates to a level deemed comparable to the difference in deterioration rates of bridges compared to pavements, as observed in the environment or seen appropriate by the roadway managing agency

26. The cross-asset roadway network funding allocation programming as claimed in claim 1, wherein occurring within but not limited to:
Microsoft Excel;
and/or commercial off-the-shelf software application(s);
and/or net application(s);
and/or existing computer application(s) within the managing agency;
and/or future computer application(s) within the managing agency.

27. The improvement program as claimed in claim 4, wherein application on the physical roadway asset occurs through roadway construction improvement scenarios of claim 21, and where the roadway construction improvements occur through construction or construction contracts in any future period of time from the commencement of the process of claim 1.

28. The agencies as claimed in claim 4 include a public or private organization managing roadway infrastructure.

29. The roadway construction improvement scenarios claimed in claim 27, wherein the renewal process of scenarios is within a managing agency, and where physical application of a scenario occurs through decisions on fund allocation according to or aided by a scenario.
